(19) United States
(12) Patent Application Publication
(10) Pub. No.: US 2016/0097013 A1
(43) Pub. Date: Apr. 7, 2016

(54) PSA Separation of Nitrogen from Natural Gas

(71) Applicant: Kent S. Knaebel, Plain City, OH (US)

(72) Inventor: Kent S. Knaebel, Plain City, OH (US)

(73) Assignee: KENT S. KNAEBEL & ASSOCIATES, INC., Dublin, OH (US)

(21) Appl. No.: 13/921,276

(22) Filed: Jun. 19, 2013

(51) Int. Cl. C10L 3/10; B01D 53/053

(52) U.S. Cl. CPC C10L 3/105; B01D 53/053; C10L 2290/542; B01D 2259/40039; B01D 2259/40052; B01D 2259/40075; B01D 2259/40079; B01D 2259/40081; B01D 2259/4061; B01D 2253/102; B01D 2253/108; B01D 2253/106; B01D 2256/245; B01D 2257/40

(57) ABSTRACT

Disclosed is a new PSA cycle that treats N₂-contaminated natural gas at relatively high pressure, and yields a first product enriched in less strongly adsorbed components such as, for example, N₂, and others (e.g., helium=He), and a second product that is enriched in more-strongly adsorbed components including, for example, CH₄ and others (e.g., ethane=C₂H₆). The new PSA cycle is characterized by: low power consumption and low adsorbent mass, and therefore relatively small adsorbers. Briefly, a five-adsorber, PSA process separates a gas mixture into a first gas product, which is enriched in a first less-strongly adsorbed component, and a second gas product, which is enriched in more-strongly adsorbed components. The second gas product may be obtained by combining effluents obtained from a series of discrete steps.

### CROSS-REFERENCE TO RELATED APPLICATIONS

None

### STATEMENT REGARDING FEDERALLY SPONSORED RESEARCH

Not applicable.

### BACKGROUND OF THE INVENTION

The present invention generally relates to the separation of gas mixtures, e.g., nitrogen from natural gas, and more particularly to the ability to provide an effective, compact, and energy-efficient device that is practically immune to pitch and yaw, which are especially important considerations for deployment on oil platforms.

When a significant amount of nitrogen appears in natural gas, the main effect is to reduce its heat of combustion, which makes it less effective for generating power or even for heating. When the nitrogen content exceeds a certain value, it is necessary to reduce it, in order for the fuel to have with acceptable energy content to be used in certain types of power generation equipment, such as, for example, turbines. Sometimes the quality of natural gas is represented by the Higher Heating Value of the gas (or HHV, e.g., in Btu per standard cubic foot of gas), or by the so-called Wobbe Index¹, which is defined as the HHV of the gas divided by the square-root of its Specific Gravity (i.e., its density relative to air, which is a key orifice-flow parameter). Basically, the Wobbe Index indicates the relative amount of energy that would flow through the orifice jet of a given burner, and it is more informative than is the HHV alone. In the above units, typical values of the Wobbe Index for commercial natural gas range from about 1,200 to 1,400 Btu/SCF, with an average being about 1,335 Btu/SCF. Table 1 shows three example gas mixtures: their compositions, molecular weights, HHVs, specific gravities (relative to air), and Wobbe Indices. According to their Wobbe Indices: Mixture 1 is significantly lower than average; Mixture 2 is unacceptably low, and Mixture 3 is slightly higher than average, but not too high. ¹ American Gas Association. Transmission Measurement Committee. AGA Report No. 4A, Natural Gas Contract Measurement and Quality Clauses. Washington, D.C.: American Gas Association, 2001.

Conventional means for separating nitrogen from natural gas can be categorized as follows: (a) those based on Pressure Swing Adsorption (PSA) and (b) those based on other unit operations. PSA systems can be further categorized into those that separate N₂ from CH₄ by exploiting differences between N₂ and CH₄: in their inherent adsorption kinetics (speed of diffusion), or in their equilibrium capacities. An example of the latter type of selectivity is shown in FIG. 1, in which it is clear that N₂ is less strongly adsorbed than CH₄, and ethane (C₂H₆) is more strongly adsorbed than CH₄.

Kuznicki, Butwell, Dolan, Mitariten, et al. of the Engelhard Corporation developed a molecular sieve (adsorbent) and PSA process that fits the former description. The technology is described in a series of patents (U.S. Pat. No. 4,938,939 issued in 1990; U.S. Pat. No. 5,989,316 issued in 1999; U.S. Pat. No. 6,068,682 issued in 2000; U.S. Pat. Nos. 6,197,092 and 6,315,817 issued in 2001; U.S. Pat. Nos. 6,444,012 and 6,497,750 issued in 2002; etc.) called the Molecular Gate®, which is a form of crystalline titanium silicate known as ETS-4 (e.g., barium or strontium exchanged), that exploits differences in inherent adsorption kinetics between N₂ and CH₄. That adsorbent is employed in a PSA unit, e.g., described in U.S. Pat. Nos. 6,197,092; 6,315,817; or 6,444,012. The gas to be treated is passed through a fixed bed of adsorbent until the medium becomes saturated with the adsorbed component(s) (particularly N₂, the molecules of which are smaller than those of CH₄, and therefore N₂ is more prone to enter the small pores in the adsorbent than is CH₄. After uptake of N₂ is complete, the adsorbent requires regeneration (e.g., via the PSA steps of blowdown, evacuation, and purge), releasing the adsorbed component(s). Typically, PSA systems employing the Molecular Gate® adsorbent require four parallel adsorbers to achieve smooth operation. Hahn revealed a similar idea, using a titanium silicate molecular sieve, in U.S. Pat. No. 6,631,626 issued in 2003). The converse type of PSA separation system, i.e., employing equilibrium-based selectivity by the adsorbent, has been disclosed by Reinhold, Knaebel, et al. in U.S. Pat. No. 5,536,300 issued in 1996 and U.S. Pat. No. 5,792,239 issued in 1998; and by Davis et al. in U.S. Pat. No. 5,174,796 issued in 1992.

Davis et al. in U.S. Pat. No. 5,174,796 describe a PSA process for natural gas purification that can reduce the content of nitrogen in natural gas. It describes a PSA cycle to produce (a) a product natural gas having reduced nitrogen content, (b) a nitrogen-rich stream, and (c) a high heat content stream for fuel use. That PSA cycle comprises some steps that are not included in the present PSA cycles. In the following description the verbatim names of the steps are capitalized. Namely, it employs an Adsorption and Feed Repressurization step, in which feed gas (natural gas) is used to repressurize an adsorber. It also uses a Co-current Purge step, which involves the introduction of product gas (i.e., rich in methane) to the adsorber and the simultaneous withdrawal of nitrogen from the effluent end of the adsorber. In addition, the '796 patent describes a Provide Purge step, and a Cocurrent Dump step, which depressures the first adsorber and produces the low heat content fuel gas product. The Adsorption and Feed Repressurization step, Co-current Purge step, Provide Purge step, and Cocurrent Dump step are not remotely found in the present PSA cycles.

Other unit operations used to separate N₂ from CH₄ include membranes (e.g., as disclosed by Baker et al., in U.S. Pat. No. 6,425,267 issued in 2002 and U.S. Pat. No. 6,630,011 issued in 2003), absorption, e.g., the so-called AET Process® of Advanced Extraction Technologies, Inc.; and one that uses an absorbent comprised of “(bis)tricyclohexylphosphine molybdenum tricarbonyl” that was reported by Bomberger, et al.; Federal Energy Technology Center, U.S. Department of Energy; Contract No: DE-AC21-95MC32265 (1999).

In addition, many cryogenic processes have been suggested for splitting N₂ from CH₄. Examples are in U.S. Pat. Nos. 4,352,685 and 4,415,345 issued in 1982 and 1983, respectively, to Swallow; U.S. Pat. No. 4,451,275 issued to Vines and Marano in 1984; U.S. Pat. No. 5,375,422 issued in 1994 to Butts; U.S. Pat. No. 6,070,429 issued to Low and Yao in 2000; U.S. Pat. No. 6,584,803 issued to Oakey in 2003; U.S. Pat. No. 6,978,638 issued in 2005 to Brostow et al.; and U.S. Pat. No. 7,059,152 issued in 2006 to Oakey and Davies. BCCK Engineering, Inc's so-called Nitech Process employs a single cryogenic distillation column, with an integral reflux condenser, for separation of methane and nitrogen as the basis of operation. The design of the internal reflux condenser and its integration into the column are key benefits over conventional cryogenic designs, which require an accumulator, pump, control equipment, and associated piping for the reflux. The Nitech process eliminates these. It is similar to a standard cryogenic distillation process.

Several five-adsorber, pressure swing adsorption (PSA) processes have been proposed previously to separate gas mixtures into a first gas product enriched in a first less strongly adsorbed gas component, and a second gas product enriched in a second more strongly adsorbed gas component. Some will be reviewed here, and the differences between those and the present invention are summarized in Table 2.

The Wagner patent, U.S. Pat. No. 3,430,418, discloses two PSA processes employing four-adsorbers or five-adsorbers for carrying out respective PSA steps on a cyclic basis. Both versions include high pressure adsorption, co-current depressurization to intermediate pressure with release of void space gas from the discharge or product end of the adsorber, counter-current depressurization to a lower desorption pressure, and repressurization to a higher adsorption pressure. Wagner discloses in both versions the so-called pressure equalization step, in which void space gas is released from one adsorber directly to another adsorber, which is initially at a lower pressure. The pressure in the two adsorbers is thereby equalized at an intermediate pressure. After each adsorber has been repressurized to an intermediate pressure level by such pressure equalization, it is further repressurized from the intermediate level in part by the countercurrent addition of product effluent to the product end of the adsorber being repressurized. Wagner states the intent of the low-pressure product: “The adsorbed components are rejected by countercurrent depressurization and purge through waste manifold 12 at the inlet end of the beds.” (emphasis added).

Doshi and Patel proposed a generic multi-adsorber (“an adsorption system having at least three adsorbent beds” . . . “to seven or more adsorbent beds”), multi-step PSA cycle in U.S. Pat. No. 4,340,398, which issued on Jul. 20, 1982. The specification of that patent says:
The invention is applicable to multi-bed PSA systems such as those having at least three adsorbent beds undergoing, on a cyclic basis, the PSA processing sequence of higher pressure adsorption, cocurrent depressurization with release of void space gas for pressure equalization with another bed, as discussed above, and typically to provide purge for a bed at a lower pressure, countercurrent depressurization to a lower desorption pressure, and repressurization to higher adsorption pressure. In the PSA field, there are important applications for which a four bed, a five bed, a six bed or a larger system can advantageously be employed to affect a desired separation. Id at col. 6, II. 32-44.
   It is so general as to be practically useless.

Patel also was awarded U.S. Pat. No. 4,650,500, which issued on Mar. 17, 1987. It describes a similar set of possible permutations of PSA cycle parameters (number of adsorbers, variety of steps, etc., such that almost any cycle could be construed; Although, the suggestions do not happen to encompass the present PSA cycle.

Two other five-adsorber PSA cycles were proposed by Fuderer in U.S. Pat. Nos. 4,468,237 and 4,726,816, which issued on Aug. 28, 1984 and Feb. 23, 1988, respectively. The former patent includes a cycle that comprises a Pressure Equalization step, a Co-current Blowdown step—into a receiver instead of a parallel adsorber, then a second Pressure Equalization step, followed by a Provide Purge step. The latter patent discloses four-bed, five-bed, and six-bed PSA processes for purifying hydrogen. The cycles all include Co-current Displacement, and Provide Purge steps, in addition to “a Co-current Depressurization-Pressure Equalization step between a bed that has completed its Co-current Displacement step and a bed that has been Purged at lower desorption pressure;” (capitalization added for the names of steps).

Another five-adsorber PSA cycle was proposed by Davis et al. in U.S. Pat. No. 5,174,796, which was issued on Dec. 29, 1992.

A similar five-adsorber cycle was proposed by Golden et al. in U.S. Pat. No. 6,027,549, which issued on Feb. 22, 2000. That patent discloses four-bed, five-bed, and six-bed PSA processes in which the “product gas is selected from the group consisting of hydrogen, helium and mixtures thereof” and is “recovered as an unadsorbed product.” The cycle includes partially pressure equalizing one adsorber with another, and Provide Purge steps, in addition to “a Co-current Depressurization-Pressure Equalization step between a bed that has completed its Co-current Displacement step and a bed that has been Purged at lower desorption pressure;” (capitalization added for the names of steps).

Practically the same five-adsorber PSA cycle was proposed by Golden et al. in U.S. Pat. No. 7,404,846 B2, which issued on Jul. 29, 2008. This patent, like the preceding one, discloses the same four-bed and five-bed PSA cycles in which the product gas is purified hydrogen and is “recovered as an unadsorbed product.” The cycle includes partially pressure equalizing one adsorber with another, and Provide Purge steps, in addition to “a Co-current Depressurization-Pressure Equalization step between a bed that has completed its Co-current Displacement step and a bed that has been Purged at lower desorption pressure;” (capitalization added for the names of steps).

A family of five-adsorber, six-adsorber, and eight-adsorber PSA processes was proposed by Kumar in U.S. Pat. No. 7,550,030 B2, which issued on Jun. 23, 2009. The five-bed version of the PSA process “produces three streams, a H₂-enriched stream, a H₂-depleted stream and a CO₂ product stream.” That cycle includes twenty time-increments but only 9-steps. Only two of those are Pressure Equalization steps; there is no Purge step; and final Re-pressurization is performed with Feed gas rather than less-strongly adsorbed product.

Another five-adsorber PSA cycle was proposed by Whitley et al. in U.S. Pat. No. 7,273,051 B2, which issued on Sep. 25, 2007. It consists of ten sequential steps, including a Hold step, and two Feed steps and two Pressure Equalization steps.

Still another five-adsorber PSA cycle was proposed by Weist, Jr., et al. in U.S. Pat. No. 7,390,350, which issued on Jun. 24, 2008. The PSA cycle proposed in that patent comprises two Pressure Equalization steps, followed by a Provide-Purge step, followed by a third Pressure Equalization step. It also employs final Pressurization via feed (instead of purified less-strongly adsorbed product).

Baksh and Simo, in U.S. Patent Application 2012/0174776 A1, which was published on Jul. 12, 2012, presented another five-adsorber PSA cycle.

The present invention may be seen by some as similar with several elements of claim 12 of the Baksh & Simo application. That claim 12 contains an element which deviates from the present invention, underlined in the following verbatim copy: “A pressure swing adsorption process for separating a pressurized supply feed gas containing one or more strongly adsorbable component from at least one less strongly adsorbable product gas component in a five bed adsorbent system to produce a continuous stream of product gas enriched in the less strongly adsorbable component and a continuous stream of offgas that is enriched in the strongly adsorbable components; wherein, the process cycle has fifteen steps including three bed-to-bed equalization steps.” In contrast, the present invention (as explained later) generates a discontinuous stream that is enriched in the more strongly adsorbed component(s), and that stream happens to be the primary product of the proposed process. Other significant features of the 5-adsorber PSA cycle detailed in the specification of the Baksh & Simo application are inconsistent with the disclosed process.

Another related PSA study was performed by Nikolic et al.². Their study examined the separation of H₂ from a H₂/CH₄/CO/CO₂ mixture (steam-methane reforming off gas) using activated carbon as an adsorbent. A non-isothermal linear driving force model was employed. Each PSA cycle involved the following steps: pressurization, adsorption, blowdown, purge, and pressure equalization by co-current depressurization and counter-current re-pressurization. Two different configurations have been considered based on the operation of the pressurization step: pressurization by feed and pressurization by the light product (H₂). They illustrated a five-adsorber process (their FIG. 1), but apparently did not specifically examine it.

To summarize, most of the prior art teaches that a 5-adsorber PSA system should employ 1 or 2 Pressure Equalization steps. A few examples teach that it is possible to employ 3 Pressure Equalization steps. All of those also employ a Provide Purge step. Thus, it is not obvious to one skilled in the art what portions of their benefits arise from their 3 Pressure Equalization steps versus their Provide Purge step. In addition, all of the prior art that teaches 3 Pressure Equalization steps also focus on production of the Less Strongly Adsorbed component(s) as the principal product. None of the prior art that teach 3 Pressure Equalization steps disclose what the equipment layout (flow-sheet) should be. In contrast, as explained below, the present invention employs 3 Pressure Equalization steps, without a Provide Purge step, and focuses on production of the More Strongly Adsorbed component(s) as the principal product. In addition, an example process layout (flow-sheet) is provided, as is the performance from some preferred embodiments. ² Nikolic, D.; Giovanoglou, A.; Georgiadis, M. C.; Kikkinides, E. S.; Modelling And Simulation Of Multi-Bed Pressure Swing Adsorption Processes; 17th European Symposium on Computer Aided Process Engineering—ESCAPE17; V. Plesu and P. S. Agachi (Eds.); Elsevier B. V. Ltd. (2007).

### BRIEF SUMMARY

Disclosed is a new PSA cycle that treats N₂-contaminated natural gas at relatively high pressure, and yields a first product enriched in less strongly adsorbed components such as, for example, N₂, and others (e.g., helium=He), and a second product that is enriched in more-strongly adsorbed components including, for example, CH₄ and others (e.g., ethane=C₂H₆). The new PSA cycle is characterized by: low power consumption and low adsorbent mass, and therefore relatively small adsorbers. Briefly, a five-adsorber, PSA process separates a gas mixture into a first gas product, which is enriched in a first less-strongly adsorbed components, and a second gas product, which is enriched in more-strongly adsorbed components. The second gas product may be obtained by combining effluents obtained from a series of discrete steps.

In the following descriptions, “co-current” means “in the same direction as the feed,” i.e., upwards, and “counter-current” means “in the opposite direction to the feed,” i.e., downwards.

Such PSA cycle includes the following sequence of at least eleven steps:

Step 1: Feed=“FD”=feeding adsorber A with pressurized feed gas containing both one or more less-strongly adsorbed components and one or more more-strongly adsorbed components. This gas generally flows upwards into adsorber A, while the gas that is enriched in the less-strongly adsorbed component(s) simultaneously flows from adsorber A and is collected in a first receiver vessel as a first product gas.
Step 2: Pressure Equalization 1 (Effluent)=“PE1(E)”=simultaneous to commencement of the Feed step (FD) in adsorber A, allowing the pressurized gas in adsorber B (enriched in the less-strongly adsorbed components) to depressurize co-currently into adsorber E, reducing the pressure in adsorber B by allowing its pressure to equalize with that in adsorber E.
Step 3: Pressure Equalization 2 (Effluent)=“PE2(E)”=while the Feed step (FD) is proceeding in adsorber A, immediately after the “PE1(E)” is complete in adsorber B, allowing the pressurized gas still in adsorber B (which is also enriched in the less-strongly adsorbed components) to depressurize co-currently into adsorber D, further reducing the pressure in adsorber B by allowing its pressure to equalize with that in adsorber D.
Step 4: Pressure Equalization 3 (Effluent)=“PE3(E)”=while the Feed step (FD) is proceeding in adsorber A, allowing the pressurized gas still in adsorber B (which is also enriched in the less-strongly adsorbed components) to depressurize co-currently into adsorber C, further reducing the pressure in adsorber B by allowing its pressure to equalize with that in adsorber C.
Step 5: Blowdown=“BD”=simultaneous to commencement of the Feed step (FD) in adsorber A, counter-currently releasing from adsorber C some of the gas that is enriched in the more-strongly adsorbed components yielding a first quantity of the second product gas, which flows into the second receiver vessel for its collection. The pressure in this step varies from the final pressure attained in “PE3(E)” to about atmospheric pressure.
Step 6: Evacuation=“EV”=while the Feed step (FD) is proceeding in adsorber A, counter-currently releasing from adsorber C some of the remaining gas that is enriched in the more-strongly adsorbed components yielding a second quantity of the second product gas, which is withdrawn from adsorber C via a vacuum pump and from there into the second receiver vessel for its collection. The pressure in this step varies from the final pressure attained in “BD” to about the limiting lowest pressure.
Step 7: Purge=“PU”=purging adsorber C by admitting a portion of the first product gas, consisting of less-strongly adsorbed components in counter-current flow in adsorber C. This step yields a third quantity of the second product gas, which is withdrawn from via a vacuum pump and from there into the second receiver vessel for its collection. The pressure in this step is about the limiting lowest pressure in the cycle.
Step 8: Pressure Equalization 3 (Influent)=“PE3(I)”=while the Feed step (FD) is proceeding in adsorber A, and simultaneous with the counterpart Pressure Equalization 3 (Effluent) “PE3(E)” step, occurring in adsorber B, allowing the pressurized gas still from adsorber B (which is enriched in the less-strongly adsorbed components) to repressurize counter-currently adsorber C, increasing the pressure in adsorber C by allowing its pressure to equalize with that in adsorber B.
Step 9: Pressure Equalization 2 (Influent)=“PE2(I)”=while the Feed step (FD) is proceeding in adsorber A, and simultaneous with the counterpart Pressure Equalization 2 (Effluent) “PE2(E)” step occurring in adsorber B, allowing the pressurized gas still from adsorber B (which is enriched in the less-strongly adsorbed components) to repressurize counter-currently adsorber D, increasing the pressure in adsorber D by allowing its pressure to equalize with that in adsorber B.
Step 10: Pressure Equalization 1 (Influent)=“PE1(I)”=simultaneous to commencement of the Feed step (FD) in adsorber A, and simultaneous with the counterpart Pressure Equalization 1 (Effluent) “PE1(E)” step occurring in adsorber B, allowing the pressurized gas still from adsorber B (which is enriched in the less-strongly adsorbed components) to repressurize counter-currently adsorber E, increasing the pressure in adsorber E by allowing its pressure to equalize with that in adsorber B.
Step 11: Repressurize (with Product)=“RP”=pressurizing adsorber E by admitting a portion of the first product gas, which is enriched in the less-strongly adsorbed components.

A number of preferred embodiments of this basic PSA cycle, with interspersed “Hold Steps” (during which no flow occurs in a specific adsorber) are possible and will be discussed later.

When natural gas containing nitrogen (as a less strongly adsorbed component) is the feed gas, the new PSA cycle can be implemented by practice of the previous steps in order to produce a first product gas that is enriched in nitrogen, and second product gas stream that is enriched in methane, which is more strongly adsorbed relative to nitrogen. Typically, the second product gas stream is comprised of three separate quantities obtained in discrete PSA steps, but which are combined into a single second product gas stream that is enriched in methane.

A key feature of the proposed PSA cycle is the synchronization of the steps, such that the five parallel adsorbers operate identically and in a coordinated fashion. This is common to all of the embodiments of the new PSA cycle. In that way, each of the five parallel adsorbers, which undergoes every one of the aforementioned eleven steps, is out-of-phase, as it were, from the other adsorbers by 2π/5.

In the proposed PSA cycle,
Adsorber A undergoes Feed (“FD”), with simultaneous production of the first product gas in the same elapsed time as:
Adsorber B sequentially undergoes Pressure Equalization 1 (Effluent)=“PE1(E)”+Pressure Equalization 2 (Effluent)=“PE2(E)”+Pressure Equalization 3 (Effluent)=“PE3(E)” while
Adsorber C sequentially undergoes Blowdown=“BD”+Evacuation=“EV”+Purge=“PU”+Pressure Equalization 3 (Influent)=“PE3(I)” while
Adsorber D sequentially undergoes Pressure Equalization 2 (Influent)=“PE2(I)” while
Adsorber E sequentially undergoes Pressure Equalization 1 (Influent)=“PE1(I)”+Repressurize with Product=“RP”

The synchronization of the steps requires that:
Pressure Equalization 1 (Influent)=“PE1(I)” coincides with Pressure Equalization 1 (Effluent)=“PE1(E)”
Pressure Equalization 2 (Influent)=“PE2(I)” coincides with Pressure Equalization 2 (Effluent)=“PE2(E)”
Pressure Equalization 3 (Influent)=“PE3(I)” coincides with Pressure Equalization 3 (Effluent)=“PE3(E)”

A critical constraint is the fact that the elapsed time of the Feed Step in adsorber A must coincide with the sequence of steps: Blowdown=“BD”+Evacuation=“EV”+Purge=“PU”+Pressure Equalization 3 (Influent)=“PE3(I)” in adsorber C. There is some degree of flexibility in adsorbers B, D, and E due to the insertion of Hold Steps. Examples are provided later.

In a general sense, the new PSA cycle can be used to separate more-strongly adsorbed gaseous components from less-strongly adsorbed components by one or more layers of adsorbent loaded identically into five parallel adsorbers. Recovery of methane from natural gas that is contaminated with nitrogen is but one desirable example of such a general process.

One skilled in the art will recognize that there is a multitude of embodiments that are functionally equivalent, but for the inclusion or omission of one or more Hold Steps in the above sequence.

Advantages of the disclosed process include the ability to generate from natural gas an enriched methane gas stream that is suitable for fuel purposes, while generating a byproduct that could be employed as a low-grade fuel. Another advantage is the PSA cycle's ability to minimize power consumption and adsorbent usage, enabling the implementation of the PSA cycle in a lightweight unit. In addition, the present invention employs fixed bed adsorbers (packed with adsorbent that is immobilized by mechanical devices within the adsorbers) along with open vessels as receivers (or accumulators), actuated valves, and other equipment. All of that is practically immune to the effects of pitch and yaw such as may occur on an oil platform deployed in a large body of water, e.g., due to waves and/or wind and to the lack of a firm foundation. For those reasons, the present invention is deemed especially suitable for deployment on an oil platform. These and other advantages will be readily apparent to those skilled in the art based on the disclosure set forth herein.

The first preferred embodiment of such a PSA cycle includes the following sequence steps:

Step 1: Feed=“FD”=feeding adsorber A with pressurized feed gas, while the gas that is enriched in the less-strongly adsorbed components flows from adsorber A and is collected in a first receiver vessel as a first product gas.
Step 2: Pressure Equalization 1 (Effluent)=“PE1(E)”=simultaneous to commencement of the Feed step (FD) in adsorber A, allowing the pressurized gas in adsorber B (enriched in the less-strongly adsorbed components) to depressurize co-currently into adsorber E, reducing the pressure in adsorber B by allowing it to equalize with that in adsorber E.
Step 3: Pressure Equalization 2 (Effluent)=“PE2(E)”=while the Feed step (FD) is proceeding in adsorber A, immediately after the “PE1(E)” is complete in adsorber B, allowing the pressurized gas still in adsorber B (which is also enriched in the less-strongly adsorbed components) to depressurize co-currently into adsorber D, further reducing the pressure in adsorber B by allowing it to equalize with that in adsorber D.
Step 4: Hold 1=“H1”=a null step for adsorber B, as there is no flow into or out of adsorber B. This step commences upon the conclusion of Step 3.
Step 5: Pressure Equalization 3 (Effluent)=“PE3(E)”=while the Feed step (FD) is proceeding in adsorber A, after the “H1” step is complete in adsorber B, allowing the pressurized gas still in adsorber B (which is also enriched in the less-strongly adsorbed components) to depressurize co-currently into adsorber C, further reducing the pressure in adsorber B by allowing it to equalize with that in adsorber C.
Step 6: Blowdown=“BD”=simultaneous to commencement of the Feed step (FD) in adsorber A, counter-currently releasing from adsorber C some of the gas that is enriched in the more-strongly adsorbed components yielding a second product gas, which flows into the second receiver vessel for its collection. The pressure in this step varies from the final pressure attained in “PE3(E)” to about atmospheric pressure.
Step 7: Evacuation=“EV”=while the Feed step (FD) is proceeding in adsorber A, counter-currently releasing from adsorber C some of the remaining gas that is enriched in the more-strongly adsorbed components yielding a third product gas, which is withdrawn from adsorber C via a vacuum pump and from there into the second receiver vessel for its collection. The pressure in this step varies from the final pressure attained in “BD” to about the limiting lowest pressure.
Step 8: Purge=“PU”=purging adsorber C with a portion of the first product gas, consisting of less-strongly adsorbed components.
Step 9: Pressure Equalization 3 (Influent)=“PE3(I)”=while the Feed step (FD) is proceeding in adsorber A, and simultaneous with the counterpart Pressure Equalization (Effluent) “PE3(E)” step, occurring in adsorber B, allowing the pressurized gas still from adsorber B (which is enriched in the less-strongly adsorbed components) to repressurize counter-currently adsorber C, increasing the pressure in adsorber C by allowing it to equalize with that in adsorber B.
Step 10: Hold 2=“H2”=simultaneous to commencement of the Feed step (FD) in adsorber A, a null step begins in adsorber D, as there is no flow into or out of adsorber D.
Step 11: Pressure Equalization 2 (Influent)=“PE2(I)”=while the Feed step (FD) is proceeding in adsorber A, at the conclusion of the Hold 2 (“H2”) step in adsorber D, and simultaneous with the counterpart Pressure Equalization (Effluent) “PE2(E)” step occurring in adsorber B, allowing the pressurized gas still from adsorber B (which is enriched in the less-strongly adsorbed components) to repressurize counter-currently adsorber D, increasing the pressure in adsorber D by allowing it to equalize with that in adsorber B.
Step 12: Hold 3=“H3”=simultaneous to conclusion of the Pressure Equalization 2 (Influent)=“PE2(I)” step in adsorber D, a null step begins in adsorber D, as there is no flow into or out of adsorber D.
Step 13: Pressure Equalization 1 (Influent)=“PE1(I)”=simultaneous to commencement of the Feed step (FD) in adsorber A, and simultaneous with the counterpart Pressure Equalization (Effluent) “PE1(E)” step occurring in adsorber B, allowing the pressurized gas still from adsorber B (which is enriched in the less-strongly adsorbed components) to repressurize counter-currently adsorber E, increasing the pressure in adsorber E by allowing it to equalize with that in adsorber B.
Step 14: Hold 4=“H4”=simultaneous to conclusion of the Pressure Equalization 1 (Influent)=“PE1(I)” step in adsorber E, a null step begins in adsorber E, as there is no flow into or out of adsorber E.
Step 15: Repressurize with Product=“RP”=pressurizing adsorber E by admitting a portion of the first product gas, which is enriched in the less-strongly adsorbed components.

The first preferred embodiment of the new PSA process is summarized in Table 3, and the synchronization of the individual steps is depicted in Table 4.

A second preferred embodiment of this PSA cycle includes the following sequence steps (with one fewer Hold Step than in the first preferred embodiment):

Step 1: Feed=“FD”=feeding adsorber A with pressurized Feed gas, while the gas that is enriched in the less-strongly adsorbed components flows from adsorber A and is collected in a first receiver vessel as a first product gas.
Step 2: Pressure Equalization 1 (Effluent)=“PE1(E)”=simultaneous to commencement of the Feed step (FD) in adsorber A, allowing the pressurized gas in adsorber B (enriched in the less-strongly adsorbed components) to depressurize co-currently into adsorber E, reducing the pressure in adsorber B by allowing it to equalize with that in adsorber E.
Step 3: Pressure Equalization 2 (Effluent)=“PE2(E)”=while the Feed step (FD) is proceeding in adsorber A, immediately after the “PE1(E)” is complete in adsorber B, allowing the pressurized gas still in adsorber B (which is also enriched in the less-strongly adsorbed components) to depressurize co-currently into adsorber D, further reducing the pressure in adsorber B by allowing it to equalize with that in adsorber D.
Step 4: Pressure Equalization 3 (Effluent)=“PE3(E)”=while the Feed step (FD) is proceeding in adsorber A, after the “PE2(E)” is complete in adsorber B, allowing the pressurized gas still in adsorber B (which is also enriched in the less-strongly adsorbed components) to depressurize co-currently into adsorber C, further reducing the pressure in adsorber B by allowing it to equalize with that in adsorber C.
Step 5: Blowdown=“BD”=simultaneous to commencement of the Feed step (FD) in adsorber A, counter-currently releasing from adsorber C some of the gas that is enriched in the more-strongly adsorbed components yielding a second product gas, which flows into the second receiver vessel for its collection. The pressure in this step varies from the final pressure attained in “PE3(E)” to about atmospheric pressure.
Step 6: Evacuation=“EV”=while the Feed step (FD) is proceeding in adsorber A, counter-currently releasing from adsorber C some of the remaining gas that is enriched in the more-strongly adsorbed components yielding a third product gas, which is withdrawn from adsorber C via a vacuum pump and from there into the second receiver vessel for its collection. The pressure in this step varies from the final pressure attained in “BD” to about the limiting lowest pressure.
Step 7: Purge=“PU”=purging adsorber C with a portion of the first product gas, consisting of less-strongly adsorbed components.
Step 8: Pressure Equalization 3 (Influent)=“PE3(I)”=while the Feed step (FD) is proceeding in adsorber A, and simultaneous with the counterpart Pressure Equalization (Effluent) “PE3(E)” step, occurring in adsorber B, allowing the pressurized gas still from adsorber B (which is enriched in the less-strongly adsorbed components) to repressurize counter-currently adsorber C, increasing the pressure in adsorber C by allowing it to equalize with that in adsorber B.
Step 9: Hold 1=“H1”=simultaneous to commencement of the Feed step (FD) in adsorber A, a null step begins in adsorber D, as there is no flow into or out of adsorber D.
Step 10: Pressure Equalization 2 (Influent)=“PE2(I)”=while the Feed step (FD) is proceeding in adsorber A, at the conclusion of the Hold 1 (“H1”) step in adsorber D, and simultaneous with the counterpart Pressure Equalization (Effluent) “PE2(E)” step occurring in adsorber B, allowing the pressurized gas still from adsorber B (which is enriched in the less-strongly adsorbed components) to repressurize counter-currently adsorber D, increasing the pressure in adsorber D by allowing it to equalize with that in adsorber B.
Step 11: Hold 2=“H2”=simultaneous to conclusion of the Pressure Equalization 2 (Influent)=“PE2(I)” step in adsorber D, a null step begins in adsorber D, as there is no flow into or out of adsorber D.
Step 12: Pressure Equalization 1 (Influent)=“PE1(I)”=simultaneous to commencement of the Feed step (FD) in adsorber A, and simultaneous with the counterpart Pressure Equalization (Effluent) “PE1(E)” step occurring in adsorber B, allowing the pressurized gas from adsorber B (which is enriched in the less-strongly adsorbed components) to repressurize counter-currently adsorber E, increasing the pressure in adsorber E by allowing it to equalize with that in adsorber B.
Step 13: Hold 3=“H3”=simultaneous to conclusion of the Pressure Equalization 1 (Influent)=“PE1(I)” step in adsorber E, a null step begins in adsorber E, as there is no flow into or out of adsorber E.
Step 14: Repressurize (with Product)=“RP”=pressurizing adsorber E by admitting a portion of the first product gas, which is enriched in the less-strongly adsorbed components.

The synchronization of the individual steps of the above second preferred embodiment of the new PSA process is summarized in Table 5. Furthermore, to illustrate the flexibility of the new PSA process, Tables 6 and 7 show two additional sequences by which the same individual steps (except for “Hold Steps”) may be synchronized.

When natural gas is the feed gas, any of the four above embodiments of the new PSA cycle can be implemented by practice of the previous steps synchronized as shown in Tables 4, 5, 6, and 7, for embodiments 1 through 4, respectively. In the first case, at the end of each set of nine numbered time intervals, as shown in Table 4, or in the latter case, at the end of each set of four numbered time intervals, as shown in Table 6, the roles of the adsorbers are also incremented. That is, the physical adsorber that was called A undergoes the steps indicated in the tables for adsorber B, and so on for adsorbers B, C, and D. The physical adsorber that was called E reverts to the role of adsorber A. In that way, each of the five parallel adsorbers undergoes every one of the steps, out-of-phase, as it were, by 2π/5.

In embodiment 1:
Adsorber A undergoes Feed (“FD”) in the same elapsed time as:
Adsorber B sequentially undergoes Pressure Equalization 1 (effluent)=“PE1(E)”+Pressure Equalization 2 (effluent)=“PE2(E)”+Hold 1=“H1”+Pressure Equalization 3 (effluent)=“PE3(E)” while
Adsorber C sequentially undergoes Blowdown=“BD”+Evacuation=“EV”+Purge=“PU”+Pressure Equalization 3 (influent)=“PE3(I)” while
Adsorber D sequentially undergoes Hold 2=“H2”+Pressure Equalization 2 (influent)=“PE2(I)”+Hold 3=“H3” while
Adsorber E sequentially undergoes Pressure Equalization 1 (influent)=“PE1(I)”+Hold 4=“H4”+Repressurize (with Product)=“RP”

In embodiment 2:
Adsorber A undergoes Feed (“FD”) in the same elapsed time as:
Adsorber B sequentially undergoes Pressure Equalization 1 (effluent)=“PE1(E)”+Pressure Equalization 2 (effluent)=“PE2(E)”+Pressure Equalization 3 (effluent)=“PE3(E)” while
Adsorber C sequentially undergoes Blowdown=“BD”+Evacuation=“EV”+Purge=“PU”+Pressure Equalization 3 (influent)=“PE3(I)” while
Adsorber D sequentially undergoes Hold 1=“H1”+Pressure Equalization 2 (influent)=“PE2(I)”+Hold 2=“H2” while
Adsorber E sequentially undergoes Pressure Equalization 1 (influent)=“PE1(I)”+Hold 3=“H3”+Repressurize (with Product)=“RP”

One skilled in the art will recognize that there is a multitude of embodiments that are functionally equivalent to embodiment 1 and embodiment 2, but for the inclusion or omission of one or more Hold Steps.

In all embodiments of the new PSA cycle, the synchronization described above and in Tables 4, 5, 6, and 7 requires that:
Pressure Equalization 1 (Influent)=“PE1(I)” coincides with Pressure Equalization 1 (Effluent)=“PE1(E)”
Pressure Equalization 2 (Influent)=“PE2(I)” coincides with Pressure Equalization 2 (Effluent)=“PE2(E)”
Pressure Equalization 3 (Influent)=“PE3(I)” coincides with Pressure Equalization 3 (Effluent)=“PE3(E)”

A critical constraint is the fact that the elapsed time of the Feed Step in adsorber A must coincide with the sequence of steps: Blowdown=“BD”+Evacuation=“EV”+Purge=“PU”+Pressure Equalization 3 (Influent)=“PE3(I)” in adsorber C. There is some degree of flexibility in adsorbers B, D, and E due to the presence of the Hold Steps, e.g., “H1,” “H2,” “H3,” and (for embodiment 1) “H4”.

In a general sense, the new 15-step PSA or 14-step cycle can be used to separate more-strongly adsorbed gaseous components from less-strongly adsorbed components by one or more layers of adsorbent loaded identically into five parallel adsorbers. Recovery of methane from natural gas that is contaminated with nitrogen is but one desirable example of such a general process.

Advantages of the disclosure include the ability to generate from natural gas an enriched methane gas stream that is suitable for fuel purposes, while generating a byproduct that could be employed as a low-grade fuel. Another advantage is the PSA cycle's ability to minimize power consumption and adsorbent usage, enabling the implementation of the PSA cycle in a lightweight unit for deployment on an oil platform. These and other advantages will be readily apparent to those skilled in the art based on the disclosure set forth herein.

### BRIEF DESCRIPTION OF THE DRAWINGS

For a fuller understanding of the nature and advantages of the present invention, reference should be had to the following detailed description taken in connection with the accompanying drawings, in which:

FIG. 1 shows isotherms of typical components comprising natural gas on activated carbon at 30° C. These thermodynamic properties establish the principle of operation of PSA systems: gases adsorb to a greater extent at high pressure, and to a lesser extent at low pressure. The difference between the amounts is called the working capacity. And, certain gases are more strongly adsorbed, while others are less strongly adsorbed under the same conditions. Thus, FIG. 1 illustrates working capacity and equilibrium-based selectivity.

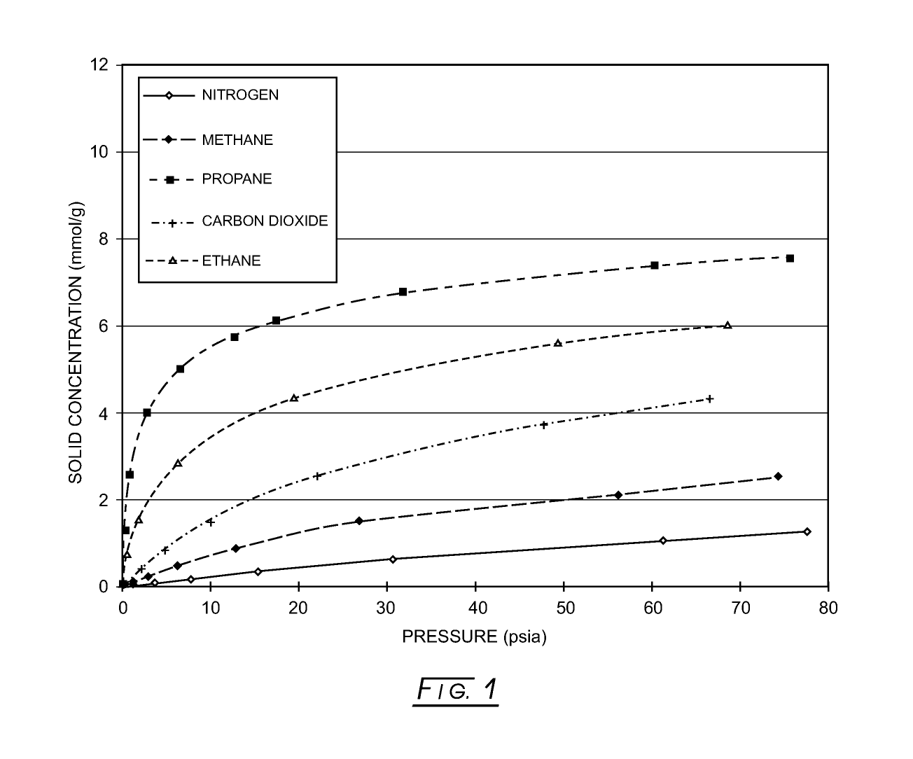

FIG. 2 illustrates the eleven individual steps of the proposed PSA cycle. So-called “hold-steps” are omitted, as there is no flow into or out of the specific adsorber during that type of step.

FIG. 3 is a possible flow-sheet of the proposed PSA cycle. It shows five valves per adsorber. As such, the manifold that collects the gas emitted from each adsorber during its respective Blowdown step is the same as that employed to collect the gas emitted from each adsorber during its respective Evacuation step and Purge step. It is a matter of engineering and economical preference whether to combine those (as shown) or to provide separate manifolds, e.g., for Blowdown and Evacuation, which would normally be combined with Purge).

The drawings will be described in detail below.

### DETAILED DESCRIPTION OF THE INVENTION

The disclosed 11-step, 5-adsorber PSA cycle utilizes the following cycle steps: Feed (with production), Pressure Equalization 1 (effluent), Pressure Equalization 2 (effluent), Pressure Equalization 3 (effluent), Blowdown, Evacuation, Purge, Pressure Equalization 3 (influent), Pressure Equalization 2 (influent), Pressure Equalization 1 (influent), and Repressurize. When natural gas that is contaminated with nitrogen is the feed, the first product is an enriched nitrogen stream, supplied at a relatively high feed pressure of around 14 to 55 bar (200 to 800 psia). The disclosed 11-step, 5-adsorber PSA cycle is designed to minimize both power required and adsorbent mass, while achieving good performance (product recovery and purity), thus enabling the design and construction of a unit that is efficient and compact.

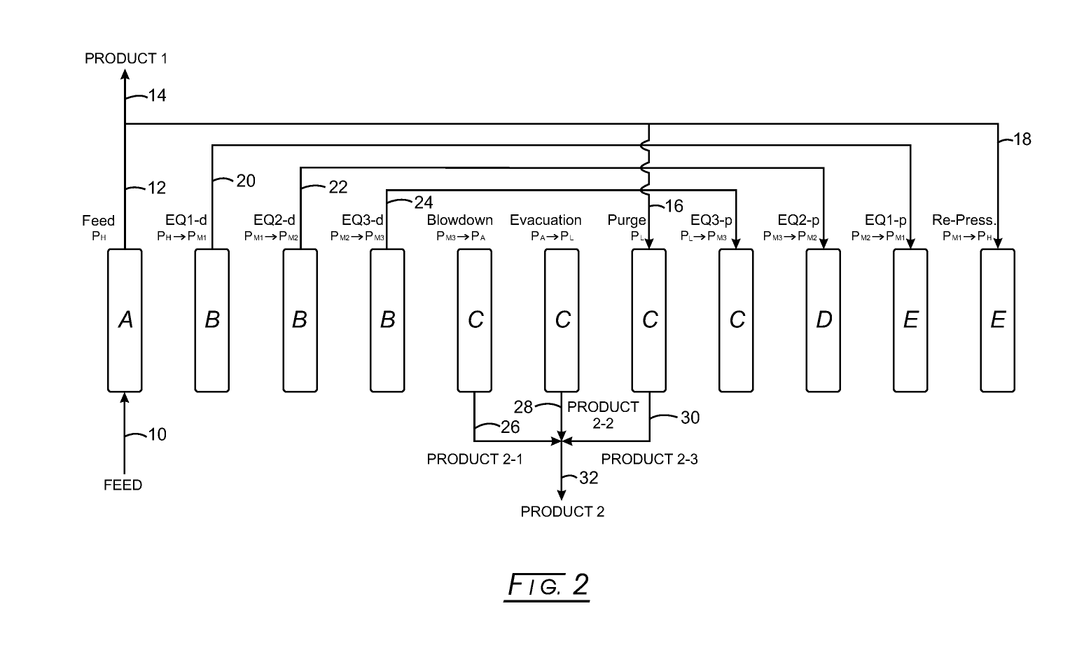

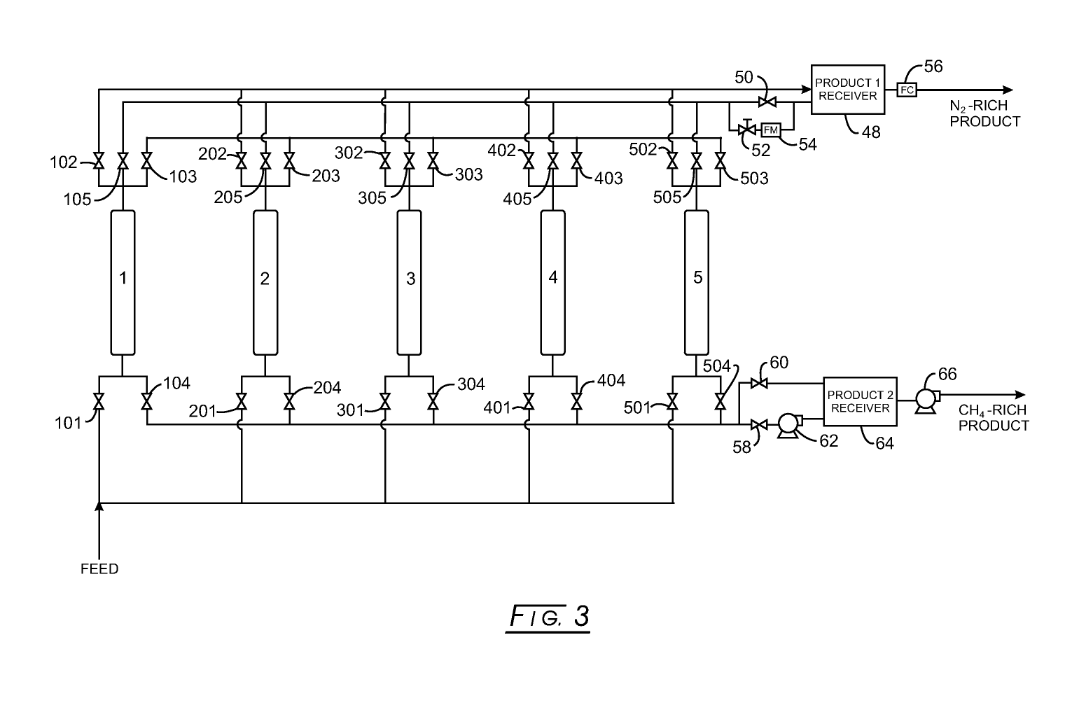

At least five adsorbers, which can be designated A, B, C, D, and E are connected in parallel. Labels of letters, instead of numbers, is intended to signify that in FIG. 2, the adsorbers represent various states or roles within the PSA cycle. As such, the state or role of each physical adsorber rotates among all of the physical adsorbers (shown in FIG. 3, numbered 1 through 5). The disclosed process generates an enriched first product gas (Product 1) comprised of an enriched, less strongly adsorbed component, and a second product gas (Product 2), comprised of enriched, more strongly adsorbed component, which may be obtained over a series of steps. When nitrogen-contaminated natural gas is the feedstock, a nitrogen-enriched gas stream is produced as Product 1, and methane enriched gas stream is produced as Product 2. While each of the five adsorbers can be composed of a single at least partially filled solid adsorbent adsorber, or multiple adsorbers connected together in-parallel, in order to provide additional treating time, capacity, or the like. Each physical adsorber can house a single type of solid adsorbent or a combination of two or more types of solid adsorbents in admixture or in sequential layers. Additional flexibility to the designer is afforded thereby.

The disclosed 11-step PSA cycle depicted schematically in FIG. 2 includes the first step, referred to as the Feed step, a feed stream, 10, containing nitrogen (less strongly adsorbed) and methane (more strongly adsorbed), is fed into adsorber A, which has been pressurized to pressure, P_{H}. A N₂ enriched stream, 12, is withdrawn from adsorber A, which is split into three portions: stream 14, which is the net Product 1, stream 16, which is used to purge adjacent adsorber C, and stream 18, which is used for pressurizing adjacent adsorber E, from P_{L} to P_{H}.

While adsorber A undergoes its Feed step, adsorber B is subjected to Pressure Equalization 1 (Effluent) with adsorber E. In so doing, adsorber B undergoes partial pressure release from P_{H} to P_{M1}, exhausting a N₂-enriched stream, 20. Adsorber B is said to operating in a co-current mode, because the direction of flow in FIG. 2 for producing the N₂-enriched stream, 20, is defined as being in an upward direction as illustrated for adsorber A, wherein feed enters the bottom of adsorber 1 and product is removed at the top of adsorber A. Counter-current flow is in the opposite, downwards direction. This convention will be used herein unless otherwise expressly indicated. Adsorber B is subjected to further Pressure Equalization 2 (Effluent) with adsorber D. In so doing, adsorber B undergoes further partial pressure release from P_{M1} to P_{M2}, exhausting a N₂-enriched stream, 22. Adsorber B is subjected to further Pressure Equalization 3 (Effluent) with adsorber 3. In so doing, adsorber B undergoes further partial pressure release from P_{M2} to P_{M3}, exhausting a N₂-enriched stream, 24.

While adsorber A undergoes its Feed step, adsorber C is operated in a counter-current Blowdown mode for removing a first portion of Product 2, shown in FIG. 2 as Product 2-1, which is enriched in the more strongly adsorbed component, e.g., methane, CH₄, shown in FIG. 2 as stream 26. In so doing, the pressure in adsorber C is reduced from P_{M3} to P_{A}. Adsorber C is subsequently operated in a counter-current Evacuation mode for removing a second portion of Product 2, shown in FIG. 2 as Product 2-2, which is also enriched in the more strongly adsorbed component, shown in FIG. 2 as stream 28. In so doing, the pressure in adsorber C is reduced from P_{A} to P_{L}. Next, adsorber C, undergoes its Purge step at a nearly steady pressure of P_{L}, in which stream 16, containing enriched less-strongly adsorbed component, e.g. N₂, is passed counter-currently therethrough for purging remaining more strongly adsorbed gaseous components (mainly CH₄), as stream 30, from adsorber C. This effluent is a third portion of Product 2, shown in FIG. 2 as Product 2-3. Adsorber C is subsequently operated in a counter-current Pressure Equalization 3 (Influent) mode, in which stream 24 from adsorber B is introduced for increasing the pressure in adsorber C from P_{L} to P_{M3}.

While adsorber A undergoes its feed step, adsorber D undergoes counter-current Pressure Equalization 2 (Influent) mode, in which stream 22 from adsorber B is introduced for increasing the pressure in adsorber D from P_{M3} to P_{M2}.

While adsorber A undergoes its feed step, adsorber E undergoes counter-current Pressure Equalization 1 (Influent) mode, in which stream 20 from adsorber B is introduced for increasing the pressure in adsorber E from P_{M2} to P_{M1}. Subsequently, adsorber E undergoes further counter-current Repressurization step, in which stream 18 from adsorber A is introduced for increasing the pressure in adsorber E from P_{M1} to P_{H}.

Streams 26, 28, and 30 may be combined, e.g., as shown in FIG. 2, to form stream 32, called Product 2, for further processing and/or other use, e.g., as a fuel.

It will be appreciated that the pressures have the following relationship: P_{L}<P_{A}<P_{M3}<P_{M2}<P_{M1}<P_{H}, where the subscript L represents “low,” the subscript A represents “atmospheric,” the subscript Mi represents various increments, i, of “medium”, and the subscript H represents “high.”

With specific reference to FIG. 3 and adsorber 1, the valves shown have the following function:
101 admits feed, i.e., when that physical adsorber is in the state of adsorber A in FIG. 2.
102 permits the first product, which is enriched in the less strongly adsorbed components, to flow from adsorber 1 to flow to Product 1 Receiver, 48, i.e., when that physical adsorber is in the state of adsorber A in FIG. 2.
103 permits gas which is enriched in the less strongly adsorbed components to flow from adsorber 1 to adsorbers 3, 4, and 5 in succession, during Pressure Equalization steps, i.e., when that physical adsorber is in the state of adsorber B in FIG. 2.
104 permits Product 2 (e.g., more strongly adsorbed components) to be withdrawn from adsorber 1, during the Blowdown, Evacuation, and Purge steps, i.e., when that physical adsorber is in the state of adsorber C in FIG. 2.
105 permits adsorber 1 to be purged and repressurized (e.g., with less strongly adsorbed components) from Product 1 Receiver, 48, i.e., when that physical adsorber is in the state of adsorber C and E, respectively, in FIG. 2.

Valves 201 through 501 serve the same function as 101, but for adsorbers 2 through 5. Likewise, valves 202 through 205, and through 502 through 505 serve the same function as those associated with adsorber 1, but for adsorbers 2 through 5, respectively.

Additionally, the vacuum pump, labeled 62, enables sub-atmospheric operation during the Evacuation and Purge steps. The gas comprising part of Product 2 emitted during those two steps, as well as in the Blowdown step, is directed to Product 2 Receiver, labeled as 64. An optional compressor, labeled 66, enables Product 2 to be compressed and employed for other uses. Also, a metering valve, 52, is shown allows less strongly adsorbed components to be used sparingly during the Purge step (measured by a Flow Meter, 54), as the gas flows from Product 1 Receiver, 48. Valve 50 opens to allow Repressurization of an adsorber (e.g., with less strongly adsorbed components) at a high flow rate relative to that during the Purge step, and that valve is closed when the sparing flow rate during the Purge step, is required.

The solid adsorbent may be selected from, for example, one or more of: activated carbon, silica gel, or hydrophobic zeolite, according to its working capacity (adsorption loading change between the uptake and regeneration steps, and according to the associated pressure shift), uptake and release kinetics, physical durability, and cost. High working capacity, fast uptake and release kinetics, good physical durability, and low cost are all desired. One may accept a higher cost of an adsorbent if it exhibits superior performance in the other characteristics.

### Test Results

Ten lab-scale PSA tests were conducted to validate the performance of the new PSA cycle. All of the tests assessed the first preferred embodiment of the PSA cycle, mentioned previously. The conditions are summarized in Tables 4, 8, 9, 10, and 11. Table 4 lists the Steps in this embodiment. Table 8 lists the Step Times for the two cycles that were evaluated. Table 9 lists the adsorbent types and amounts (mass per adsorber) that were employed. Table 10 lists the feed compositions, which were similar. Finally, Table 11 lists additional conditions and results of the tests.

Table 11 shows that several parameters were varied systematically, besides those listed in Tables 8, 9, and 10. For instance, the Feed Pressure was varied between 218 psia and 758 psia. Likewise, the Feed Flow Rate was varied between 3.18 standard liters per minute (slm) and 6.3 slm, though the adsorber volume was fixed. Finally, the Purge Flow Rate was varied between 0.012 slm and 0.083 slm.

It is known to those skilled in the art of PSA separations that the results of laboratory-scale tests generally compare nearly linearly with commercial-scale operations, when the same adsorbent, pressures, cycle, etc. are employed. Therefore, the results of the present tests provide a useful guide to the implementation of a commercial-scale system. Furthermore, it is known to those skilled in the art that the key performance indicators of a PSA system are: product purity and hydrocarbon recovery, both with respect to the second product, feed pressure, and feed throughput. Those strongly affect the capital cost, operating expense, and revenue for a system. Considering these individually, using the results listed in Table 11:

Product 2 Purity—All of the test results were similar, but those for Tests 2 and 9 were slightly worse (higher N₂ contents in Product 2). Thus, no particular combination of design or operating parameters is preferred on this basis.

Hydrocarbon Recovery—Product 2—Recovery is defined as: the specified components' composition×flow rate in the product stream, divided by the respective composition×flow rate in the feed stream. High recovery translates to more revenue and less waste. The results of the first five Tests were all in the 70% to 80% range, and were inferior to those for Tests 6 through 10, which were approximately 84% to 87%.

Feed Pressure—The capital cost of the adsorption vessels will be less for a lower feed pressure, on account of the associated thinner wall thickness. Therefore, Tests conducted below 400 psia (viz., Tests 5 through 10) are deemed to be superior to those above 400 psia (viz., Tests 1 through 4)

Feed Throughput—Generally, high values lead to low capital cost. The first row of values listed in Table 11 is in units of “SCFM/lb_{ads-bed}” and thus those values relate to the adsorbent cost. The second row of values listed in Table 11 is in units of “SCFM/ft³_{ads-bed}” and thus those values relate to the adsorber vessel cost. The results of Test 3 stand out as being superior on both counts to those of the other tests. However, the results of Tests 1, 2, 9, and 10 are also very good.

For the current tests, based on the above criteria, it is clear that each application must be assessed based on engineering and economic principles that will be affected by extraneous factors. Nevertheless, the results of Test 10 are very good on all counts. It is the result of testing with the inventive PSA cycle, employing the shorter cycle time, i.e., 315 s, Adsorbent 2, and a moderate Feed Pressure of 387 psia.

Overall, it would appear that for this application the inventive 11-step 5-adsorber PSA cycle, with conditions and parameters as defined by Test 10 in Table 11, exhibited the best overall performance, considering the purity and recovery of the second product, the feed pressure, and the mass of adsorbent required.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

TABLE 1
Example Compositions, Densities, And
Wobbe Indices For Three Gas Mixtures.

| | Mixture 1 | Mixture 2 | Mixture 3 |
|---|---|---|---|
| Component | Mole % | Mole % | Mole % |
| CH4 | 80.96 | 56.10 | 84.56 |
| CO2 | 0.74 | 0.00 | 0.84 |
| C2H6 | 6.94 | 0.00 | 8.01 |
| C3H8 | 4.37 | 0.00 | 4.98 |
| N2 | 7.00 | 43.90 | 1.61 |
| Sum | 100.00 | 100.00 | 100.00 |
| Avg. Molecular Wt. | 19.28 | 21.30 | 18.99 |
| Specific Grav. | 0.665 | 0.734 | 0.655 |
| Btu Content per SCF | 1,049.9 | 566.3 | 1,120.6 |
| Wobbe Index | 1,287.5 | 660.8 | 1,384.9 |

TABLE 2
Summary of Previous 5-Adsorber PSA Cycles

| | | | | | No. |
|---|---|---|---|---|---|
| | | | | | Valves |
| | U.S. Patent/ | No. | Provide | | Per |
| Inventor | Application No. | Equalizations | Purge | Principal Product(s) | Adsorber |
| Wagner | 3,430,418 | 2 | Yes | Less Strongly Adsorbed | 8+ |
| Doshi & Patel | 4,340,398 | 1 | Yes | Less Strongly Adsorbed | ? |
| Patel | 4,650,500 | 2 | Yes | Less Strongly Adsorbed | |
| Fuderer | 4,468,237 | 2 | Yes | Less Strongly Adsorbed | ? |
| Fuderer | 4,726,816 | 1 | Yes | Less Strongly Adsorbed | ? |
| Davis et al. | 5,174,796 | 2 | Yes | Product + By-Product + | 5.6 |
| | | | | Vent | |
| Golden et al. | 6,027,549 | 3 | Yes | Less Strongly Adsorbed | ? |
| Golden et al. | 7,404,846 | 3 | Yes | Less Strongly Adsorbed | ? |
| Kumar | 7,550,030 | 2 | No | H₂-enriched + H₂-depleted + | 6 |
| | | | | CO₂ product | |
| Whitley et al. | 7,273,051 | 2 | No | Less Strongly Adsorbed | ? |
| Weist, Jr., et al. | 7,390,350 | 3 | Yes | Less Strongly Adsorbed | ? |
| Baksh & Simo | 2012/0174776 A1 | 3 | Yes | Less Strongly Adsorbed | ? |

TABLE 3
PSA Steps of the First Preferred Embodiment of the Disclosed Cycle.

| Step | | Step Description |
|---|---|---|
| 1 | FD | Feed admitted vertically upwards into adsorber A at P_{H} yielding N₂-rich first product |
| 2 | PE1(E) | 1^{st} Co-current depressurization to P_{PE1} for PE1 adsorber B with adsorber E. |
| 3 | PE2(E) | 2^{nd} Co-current depressurization to P_{PE2} for PE2 adsorber B with adsorber D. |
| 4 | H1 | 1^{st} Hold step without flow at P_{PE3} of adsorber B for synchronization of steps. |
| 5 | PE3(E) | 3^{rd} Co-current depressurization to P_{PE3} for PE3 adsorber B with adsorber C. |
| 6 | BD | Counter-current blowdown of adsorber C to P_{ATM}., yielding CH₄-rich second product |
| 7 | EV | Counter-current evacuation of adsorber C to P_{L} (lowest pressure) yielding CH₄-rich second |
| | | product |
| 8 | PU | Counter-current introduction of N₂-rich first product to adsorber C at P_{L} yielding CH₄-rich |
| | | second product |
| 9 | PE3(I) | Counter-current re-pressurization to P_{PE3} of adsorber C for PE3 with adsorber B. |
| 10 | H2 | 2^{nd} Hold step without flow at P_{PE3} of adsorber D for synchronization of steps. |
| 11 | PE2(I) | Counter-current re-pressurization to P_{PE2} of adsorber D for PE2 with adsorber B. |
| 12 | H3 | 3^{rd} Hold step without flow at P_{PE2} of adsorber D for synchronization of steps. |
| 13 | PE1(I) | Counter-current re-pressurization to P_{PE1} of adsorber E for PE1 with adsorber B. |
| 13 | H4 | 4^{th} Hold step without flow at P_{PE1} of adsorber E for synchronization of steps. |
| 14 | RP | Counter-current re-pressurization to P_{H} of adsorber E with N₂-rich first product. |

“cocurrent” = vertically upwards
“countercurrent” = vertically downwards

TABLE 4
Synchronization of the PSA Steps of the First Preferred Embodiment
of the Disclosed Cycle.

| Adsorber | Steps for 1/5 of Proposed PSA Cycle | | | | | | | | |
|---|---|---|---|---|---|---|---|---|---|
| Interval | 1 | 2 | 3 | 4 | 5 | 6 | 7 | 8 | 9 |

| A | FD | | | |
|---|---|---|---|---|
| B | PE1(E) | PE2(E) | H1 | PE3(E) |

| | | | | |
|---|---|---|---|---|
| C | BD | EV | PU | PE3(I) |

| | | | |
|---|---|---|---|
| D | H2 | PE2(I) | H3 |

| | | | |
|---|---|---|---|
| E | PE1(I) | H4 | PP |

TABLE 5
Synchronization of the PSA Steps of the Second
Preferred Embodiment of the Disclosed Cycle.

| | |
|---|---|
| Adsorber | Steps for 1/5 of Proposed PSA Cycle |

| | | | | |
|---|---|---|---|---|
| Interval | 1 | 2 | 3 | 4 |

| | |
|---|---|
| A | FD |

| | | | |
|---|---|---|---|
| B | PE1(E) | PE2(E) | PE3(E) |

| | | | | |
|---|---|---|---|---|
| C | BD | EV | PU | PE3(I) |

| | | | |
|---|---|---|---|
| D | H1 | PE2(I) | H2 |
| E | PE1(I) | H3 | PP |

TABLE 6
Synchronization of the PSA Steps of the Third
Preferred Embodiment of the Disclosed Cycle.

| | |
|---|---|
| Adsorber | Steps for 1/5 of Proposed PSA Cycle |

| | | | | | |
|---|---|---|---|---|---|
| Interval | 1 | 2 | 3 | 4 | 5 |

| | |
|---|---|
| A | FD |

| | | | |
|---|---|---|---|
| B | PE1(E) | PE2(E) | PE3(E) |

| | | | | |
|---|---|---|---|---|
| C | BD | EV | PU | PE3(I) |

| | | | |
|---|---|---|---|
| D | H1 | PE2(I) | H2 |
| E | PE1(I) | H3 | PP |

TABLE 7
Synchronization of the PSA Steps of the Fourth Preferred Embodiment of
the Disclosed Cycle.

| Adsorber | Steps for 1/5 of Proposed PSA Cycle | | | | | |
|---|---|---|---|---|---|---|
| Interval | 1 | 2 | 3 | 4 | 5 | 6 |

| A | FD | | |
|---|---|---|---|
| B | PE1(E) | PE2(E) | PE3(E) |

| | | | | |
|---|---|---|---|---|
| C | BD | EV | PU | PE3(I) |

| | | | |
|---|---|---|---|
| D | H1 | PE2(I) | H2 |
| E | PE1(I) | H3 | PP |

TABLE 8
Experimental PSA Tests: Step Sequences and
Durations for Preferred Embodiment 1.

| | Cycle 1 | Cycle 2 |
|---|---|---|
| PSA Step | S | S |
| FD | 90 | 63 |
| PE1(E) | 20 | 14 |
| PE2(E) | 30 | 21 |
| H1 | 20 | 14 |
| PE3(E) | 20 | 14 |
| BD | 10 | 7 |
| EV | 30 | 21 |
| PU | 30 | 21 |
| PE3(I) | 20 | 14 |
| H2 | 20 | 14 |
| PE2(I) | 30 | 21 |
| H3 | 40 | 28 |
| PE1(I) | 20 | 14 |
| H4 | 50 | 35 |
| RP | 20 | 14 |
| Total Cycle | 450 | 315 |

TABLE 9
Experimental PSA Tests: Adsorbent
Types and Masses per Adsorber.

| | Mass |
|---|---|
| Adsorbent Type | g/bed |
| Activated Carbon A | 63.91 |
| Activated Carbon B | 90.13 |

TABLE 10
Experimental Feed Compositions.

| | Mixture 1 | Mixture 2 |
|---|---|---|
| Component | Mole % | Mole % |
| CH₄ | 79.361 | 80.92 |
| N₂ | 7.590 | 7.01 |
| C₂H₆ | 7.520 | 6.95 |
| C₃H₈ | 4.733 | 4.38 |
| CO₂ | 0.796 | 0.74 |
| Total | 100.000 | 100.000 |

TABLE 11
Experimental PSA Test Conditions and Results.

| Test | | | 1 | 2 | 3 | 4 | 5 | 6 | 7 | 8 | 9 | 10 |
|---|---|---|---|---|---|---|---|---|---|---|---|---|
| Cycle Time | | s | 450 | | | | | | | | 315 | |
| Adsorbent | | | Activated Carbon A | | | | | Activated Carbon B | | | | |
| Feed Mixture | | | Mixture 1 | | Mixture 2 | | | | | | | |
| Feed Pressure | | psia | 631.0 | 612.0 | 758.0 | 436.0 | 331.0 | 308.0 | 218.0 | 390.0 | 384.0 | 387.0 |
| Vacuum Pressure | | psia | 2.5 | 2.48 | 2.51 | 2.42 | 2.41 | 2.9 | 2.95 | 2.9 | 3.4 | 2.42 |
| Feed Flow Rate | | slm | 5.415 | 5.401 | 5.870 | 4.280 | 3.601 | 3.818 | 3.186 | 4.406 | 6.060 | 6.304 |
| Purge Flow Rate | | slm | 0.023 | 0.012 | 0.012 | 0.012 | 0.012 | 0.083 | 0.083 | 0.083 | 0.083 | 0.065 |
| Product 2 | CH₄ | % | 80.91 | 79.97 | 82.03 | 81.90 | 81.97 | 83.42 | 83.69 | 83.48 | 83.55 | 83.20 |
| | N₂ | | 1.70 | 2.26 | 1.94 | 1.95 | 1.93 | 1.41 | 1.57 | 1.82 | 2.20 | 1.91 |
| | C₂H₆ | | 9.97 | 10.23 | 8.98 | 9.15 | 9.17 | 8.67 | 8.41 | 8.39 | 8.15 | 8.51 |
| | C₃H₈ | | 6.33 | 6.42 | 6.06 | 6.00 | 5.95 | 5.54 | 5.41 | 5.36 | 5.17 | 5.41 |
| | CO₂ | | 1.09 | 1.12 | 0.99 | 1.00 | 0.98 | 0.96 | 0.92 | 0.95 | 0.93 | 0.97 |
| | Total | | 100.00 | 100.00 | 100.00 | 100.00 | 100.00 | 100.00 | 100.00 | 100.00 | 100.00 | 100.00 |
| | Flow Rate | slm | 3.676 | 4.016 | 4.023 | 3.198 | 2.651 | 3.035 | 2.618 | 3.583 | 5.001 | 5.027 |
| Product 1* | CH₄ | % | 76.20 | 77.60 | 78.70 | 78.60 | 78.50 | 71.85 | 68.10 | 70.80 | 70.60 | 71.50 |
| | N₂ | | 23.80 | 22.40 | 21.30 | 21.40 | 21.50 | 28.15 | 31.90 | 29.20 | 29.40 | 28.50 |
| | CO₂ | | 0.00 | 0.00 | 0.00 | 0.00 | 0.00 | 0.00 | 0.00 | 0.00 | 0.00 | 0.00 |
| | Total | | 100.00 | 100.00 | 100.00 | 100.00 | 100.00 | 100.00 | 100.00 | 100.00 | 100.00 | 100.00 |
| | Flow Rate | slm | 1.059 | 1.385 | 1.397 | 1.082 | 0.950 | 0.783 | 0.568 | 0.823 | 1.059 | 1.277 |

| | | | | | | | | | | | |
|---|---|---|---|---|---|---|---|---|---|---|---|
| Hydrocarbon Recovery - Product 2 | % | 72.03 | 78.42 | 72.12 | 78.61 | 77.48 | 84.13 | 86.86 | 85.71 | 86.66 | 83.96 |

| | | | | | | | | | | | |
|---|---|---|---|---|---|---|---|---|---|---|---|
| Feed Throughput | SCFM/lb_{ads-bed} | 1.434 | 1.431 | 1.555 | 1.134 | 0.954 | 0.717 | 0.598 | 0.828 | 1.138 | 1.184 |
| | SCFM/ft³_{ads-bed} | 24.90 | 24.90 | 26.99 | 19.68 | 16.54 | 15.58 | 12.98 | 17.96 | 24.66 | 25.53 |

*Product 1 composition was measured only for CH₄, CO₂, and N₂.

I claim:

1. A parallelly-connected five adsorber, pressure swing adsorption (PSA) process for separating a gas mixture into a first gas product enriched in a first less strongly adsorbed gas component, and a second gas product enriched in a second more strongly adsorbed gas component, wherein each of said adsorbers is at least partially filled with solid adsorbent, which comprises the steps of:
Step 1: Feed=feeding adsorber A with pressurized feed gas containing both one or more less-strongly adsorbed components and one or more more-strongly adsorbed components, while the gas that is enriched in the less-strongly adsorbed component(s) simultaneously flows from adsorber A and is collected in a first receiver vessel as a first product gas;
Step 2: Pressure Equalization 1 (Effluent)=simultaneous to commencement of the Feed step in adsorber A, allowing the pressurized gas in adsorber B (enriched in the less-strongly adsorbed components) to depressurize co-currently into adsorber E, reducing the pressure in adsorber B by allowing its pressure to equalize with that in adsorber E;
Step 3: Pressure Equalization 2 (Effluent)=while the Feed step is proceeding in adsorber A, immediately after Step 2 is complete in adsorber B, allowing the pressurized gas still in adsorber B (which is also enriched in the less-strongly adsorbed components) to depressurize co-currently into adsorber D, further reducing the pressure in adsorber B by allowing its pressure to equalize with that in adsorber D;
Step 4: Pressure Equalization 3 (Effluent)=while the Feed step is proceeding in adsorber A, allowing the pressurized gas still in adsorber B (which is also enriched in the less-strongly adsorbed components) to depressurize co-currently into adsorber C, further reducing the pressure in adsorber B by allowing its pressure to equalize with that in adsorber C;
Step 5: Blowdown=simultaneous to commencement of the Feed step in adsorber A, counter-currently releasing from adsorber C some of the gas that is enriched in the more-strongly adsorbed components yielding a first quantity of the second product gas, which flows into the second receiver vessel for its collection. The pressure in this step varies from the final pressure attained in Step 4 to about atmospheric pressure;
Step 6: Evacuation=while the Feed step is proceeding in adsorber A, counter-currently releasing from adsorber C some of the remaining gas that is enriched in the more-strongly adsorbed components yielding a second quantity of the second product gas, which is withdrawn from adsorber C via a vacuum pump and from there into the second receiver vessel for its collection. The pressure in this step varies from the final pressure attained in Step 5 to about the limiting lowest pressure;
Step 7: Purge=purging adsorber C by admitting a portion of the first product gas, consisting of less-strongly adsorbed components in counter-current flow in adsorber C. This step yields a third quantity of the second product gas, which is withdrawn from via a vacuum pump and from there into the second receiver vessel for its collection. The pressure in this step is about the limiting lowest pressure in the cycle;
Step 8: Pressure Equalization 3 (Influent)=while the Feed step is proceeding in adsorber A, and simultaneous with the counterpart Pressure Equalization 3 (Effluent) step, occurring in adsorber B, allowing the pressurized gas still from adsorber B (which is enriched in the less-strongly adsorbed components) to repressurize counter-currently adsorber C, increasing the pressure in adsorber C by allowing its pressure to equalize with that in adsorber B;
Step 9: Pressure Equalization 2 (Influent)=while the Feed step is proceeding in adsorber A, and simultaneous with the counterpart Pressure Equalization 2 (Effluent) step occurring in adsorber B, allowing the pressurized gas still from adsorber B (which is enriched in the less-strongly adsorbed components) to repressurize counter-currently adsorber D, increasing the pressure in adsorber D by allowing its pressure to equalize with that in adsorber B;
Step 10: Pressure Equalization 1 (Influent)=simultaneous to commencement of the Feed step in adsorber A, and simultaneous with the counterpart Pressure Equalization 1 (Effluent) step occurring in adsorber B, allowing the pressurized gas still from adsorber B (which is enriched in the less-strongly adsorbed components) to repressurize counter-currently adsorber E, increasing the pressure in adsorber E by allowing its pressure to equalize with that in adsorber B; and
Step 11: Repressurize (with Product)=pressurizing adsorber E by admitting a portion of the first product gas, which is enriched in the less-strongly adsorbed components.

2. The PSA process of claim 1, wherein the duration of Step 1 is about twice to nine-times that of each of the other steps.

3. The PSA process of claim 1, wherein said solid adsorbent is one or more of activated carbon, silica gel, or hydrophobic zeolite.

4. The PSA process of claim 1, wherein said gas mixture comprises natural gas containing an undesirably high level of nitrogen.

5. The PSA process of claim 1, wherein each physical adsorber: 1, 2, 3, 4, and 5, or according to their states: A, B, C, D, and E, independently are comprised of one or more adsorbers.

6. A pressure swing adsorption (PSA) process for generating methane-enriched product gas from nitrogen-contaminated natural gas, which comprises the steps of:
Step 1:
Feed=“FD”=feeding an adsorber A with pressurized nitrogen-contaminated natural gas, while the gas that is enriched in the less-strongly adsorbed components flows from adsorber A and is collected in a first receiver vessel as a first product gas;
Step 2:
Pressure Equalization 1 (Effluent)=“PE1(E)”=simultaneous to commencement of the Feed step (FD) in adsorber A, allowing the pressurized gas in an adsorber B (enriched in the less-strongly adsorbed components) to depressurize co-currently into an adsorber E, reducing the pressure in said adsorber B by allowing it to equalize with that in adsorber E;
Step 3:
Pressure Equalization 2 (Effluent)=“PE2(E)”=while the Feed step (FD) is proceeding in adsorber A, immediately after the “PE1(E)” is complete in adsorber B, allowing the pressurized gas still in said adsorber B (which is also enriched in the less-strongly adsorbed components) to depressurize co-currently into adsorber D, further reducing the pressure in adsorber B by allowing it to equalize with that in said adsorber D;
Step 4:
Hold 1=“H1”=a null step for adsorber B, as there is no flow into or out of adsorber B. This step commences upon the conclusion of Step 3.
Step 5:
Pressure Equalization 3 (Effluent)=“PE3(E)”=while the Feed step (FD) is proceeding in adsorber A, after the “H1” step is complete in adsorber B, allowing the pressurized gas still in adsorber B (which is also enriched in the less-strongly adsorbed components) to depressurize co-currently into an adsorber C, further reducing the pressure in adsorber B by allowing it to equalize with that in adsorber C;
Step 6:
Blowdown=“BD”=simultaneous to commencement of the Feed step (FD) in adsorber A, counter-currently releasing from adsorber C some of the gas that is enriched in the more-strongly adsorbed components yielding a second product gas, which flows into the second receiver vessel for its collection, the pressure in this step varying from the final pressure attained in “PE3(E)” to about atmospheric pressure;
Step 7:
Evacuation=“EV”=while the Feed step (FD) is proceeding in adsorber A, counter-currently releasing from adsorber C some of the remaining gas that is enriched in the more-strongly adsorbed components yielding a third product gas, which is withdrawn from adsorber C via a vacuum pump and from there into the second receiver vessel for its collection, the pressure in this step varying from the final pressure attained in “BD” to about the limiting lowest pressure;
Step 8:
Purge=“PU”=purging adsorber C with a portion of the first product gas, comprising less-strongly adsorbed components;
Step 9:
Pressure Equalization 3 (Influent)=“PE3(I)”=while the Feed step (FD) is proceeding in adsorber A, and simultaneous with the counterpart Pressure Equalization (Effluent) “PE3(E)” step, occurring in adsorber B, allowing the pressurized gas still from adsorber B (which is enriched in the less-strongly adsorbed components) to repressurize counter-currently adsorber C, increasing the pressure in adsorber C by allowing it to equalize with that in adsorber B;
Step 10:
Hold 2=“H2”=simultaneous to commencement of the Feed step (FD) in adsorber A, a null step begins in adsorber D, as there is no flow into or out of adsorber D;
Step 11:
Pressure Equalization 2 (Influent)=“PE2(I)”=while the Feed step (FD) is proceeding in adsorber A, at the conclusion of the Hold 2 (“H2”) step in adsorber D, and simultaneous with the counterpart Pressure Equalization (Effluent) “PE2(E)” step occurring in adsorber B, allowing the pressurized gas still from adsorber B (which is enriched in the less-strongly adsorbed components) to repressurize counter-currently adsorber D, increasing the pressure in adsorber D by allowing it to equalize with that in adsorber B;
Step 12:
Hold 3=“H3”=simultaneous to conclusion of the Pressure Equalization 2 (Influent)=“PE2(I)” step in adsorber D, a null step begins in adsorber D, as there is no flow into or out of adsorber D;
Step 13:
Pressure Equalization 1 (Influent)=“PE1(I)”=simultaneous to commencement of the Feed step (FD) in adsorber A, and simultaneous with the counterpart Pressure Equalization (Effluent) “PE1(E)” step occurring in adsorber B, allowing the pressurized gas still from adsorber B (which is enriched in the less-strongly adsorbed components) to repressurize counter-currently in an adsorber E, increasing the pressure in adsorber E by allowing it to equalize with that in adsorber B;
Step 14:
Hold 4=“H4”=simultaneous to conclusion of the Pressure Equalization 1 (Influent)=“PE1(I)” step in adsorber E, a null step begins in adsorber E, as there is no flow into or out of adsorber E; and
Step 15:
Repressurize with Product=“RP”=pressurizing adsorber E by admitting a portion of the first product gas, which is enriched in the less-strongly adsorbed components. wherein adsorbers A, B, and C each are at least partially filled with solid adsorbent.

7. The PSA process of claim 6, wherein synchronization of the individual steps is depicted in Table 4:
TABLE 4

| Absorber | Steps | | | | | | | | |
|---|---|---|---|---|---|---|---|---|---|
| Interval | 1 | 2 | 3 | 4 | 5 | 6 | 7 | 8 | 9 |
| A | FD | | | |
|---|---|---|---|---|
| B | PE1(E) | PE2(E) | H1 | PE3(E) |
| | | | | |
|---|---|---|---|---|
| C | BD | EV | PU | PE2(I) |
| | | | |
|---|---|---|---|
| D | H2 | PE2(I) | H3 |
| | | | |
|---|---|---|---|
| E | PE1(I) | H4 | PP |

8. A pressure swing adsorption (PSA) process for generating methane-enriched product gas from nitrogen-contaminated natural gas, which comprises the steps of:
Step 1:
Feed=“FD”=feeding an adsorber A with Feed gas comprising pressurized nitrogen-contaminated natural gas, while the gas that is enriched in the less-strongly adsorbed components flows from adsorber A and is collected in a first receiver vessel as a first product gas;
Step 2:
Pressure Equalization 1 (Effluent)=“PE1(E)”=simultaneous to commencement of the Feed step (FD) in adsorber A, allowing the pressurized gas in an adsorber B (enriched in the less-strongly adsorbed components) to depressurize co-currently into an adsorber E, reducing the pressure in adsorber B by allowing it to equalize with that in adsorber E;
Step 3:
Pressure Equalization 2 (Effluent)=“PE2(E)”=while the Feed step (FD) is proceeding in adsorber A, immediately after the “PE1(E)” is complete in adsorber B, allowing the pressurized gas still in adsorber B (which is also enriched in the less-strongly adsorbed components) to depressurize co-currently into an adsorber D, further reducing the pressure in adsorber B by allowing it to equalize with that in adsorber D;
Step 4:
Pressure Equalization 3 (Effluent)=“PE3(E)”=while the Feed step (FD) is proceeding in adsorber A, after the “PE2(E)” is complete in adsorber B, allowing the pressurized gas still in adsorber B (which is also enriched in the less-strongly adsorbed components) to depressurize co-currently into an adsorber C, further reducing the pressure in adsorber B by allowing it to equalize with that in adsorber C;
Step 5:
Blowdown=“BD”=simultaneous to commencement of the Feed step (FD) in adsorber A, counter-currently releasing from adsorber C some of the gas that is enriched in the more-strongly adsorbed components yielding a second product gas, which flows into the second receiver vessel for its collection, the pressure in this step varying from the final pressure attained in “PE3(E)” to about atmospheric pressure;
Step 6:
Evacuation=“EV”=while the Feed step (FD) is proceeding in adsorber A, counter-currently releasing from adsorber C some of the remaining gas that is enriched in the more-strongly adsorbed components yielding a third product gas, which is withdrawn from adsorber C via a vacuum pump and from there into the second receiver vessel for its collection, the pressure in this step varying from the final pressure attained in “BD” to about the limiting lowest pressure;
Step 7:
Purge=“PU”=purging adsorber C with a portion of the first product gas, consisting of less-strongly adsorbed components;
Step 8:
Pressure Equalization 3 (Influent)=“PE3(I)”=while the Feed step (FD) is proceeding in adsorber A, and simultaneous with the counterpart Pressure Equalization (Effluent) “PE3(E)” step, occurring in adsorber B, allowing the pressurized gas still from adsorber B (which is enriched in the less-strongly adsorbed components) to repressurize counter-currently adsorber C, increasing the pressure in adsorber C by allowing it to equalize with that in adsorber B;
Step 9:
Hold 1=“H1”=simultaneous to commencement of the Feed step (FD) in adsorber A, a null step begins in adsorber D, as there is no flow into or out of adsorber D;
Step 10:
Pressure Equalization 2 (Influent)=“PE2(I)”=while the Feed step (FD) is proceeding in adsorber A, at the conclusion of the Hold 1 (“H1”) step in adsorber D, and simultaneous with the counterpart Pressure Equalization (Effluent) “PE2(E)” step occurring in adsorber B, allowing the pressurized gas still from adsorber B (which is enriched in the less-strongly adsorbed components) to repressurize counter-currently adsorber D, increasing the pressure in adsorber D by allowing it to equalize with that in adsorber B;
Step 11:
Hold 2=“H2”=simultaneous to conclusion of the Pressure Equalization 2 (Influent)=“PE2(I)” step in adsorber D, a null step begins in adsorber D, as there is no flow into or out of adsorber D;
Step 12:
Pressure Equalization 1 (Influent)=“PE1(I)”=simultaneous to commencement of the Feed step (FD) in adsorber A, and simultaneous with the counterpart Pressure Equalization (Effluent) “PE1(E)” step occurring in adsorber B, allowing the pressurized gas from adsorber B (which is enriched in the less-strongly adsorbed components) to repressurize counter-currently adsorber E, increasing the pressure in adsorber E by allowing it to equalize with that in adsorber B;
Step 13:
Hold 3=“H3”=simultaneous to conclusion of the Pressure Equalization 1 (Influent)=“PE1(I)” step in adsorber E, a null step begins in adsorber E, as there is no flow into or out of adsorber E; and
Step 14:
Repressurize (with Product)=“RP”=pressurizing adsorber E by admitting a portion of the first product gas, which is enriched in the less-strongly adsorbed components.

9. The PSA process of claim 8, wherein synchronization of the individual steps is depicted in Table 5:
TABLE 5

| | |
|---|---|
| Adsorber | Steps |
| | | | | |
|---|---|---|---|---|
| Interval | 1 | 2 | 3 | 4 |
| | |
|---|---|
| A | FD |
| | | | |
|---|---|---|---|
| B | PE1(E) | PE2(E) | PE3(E) |
| | | | | |
|---|---|---|---|---|
| C | BD | EV | PU | PE3(I) |
| | | | |
|---|---|---|---|
| D | H1 | PE2(I) | H2 |
| E | PE1(I) | H3 | PP |

10. A parallelly-connected five adsorber, pressure swing adsorption (PSA) process for separating a gas mixture into a first gas product enriched in a first less strongly adsorbed gas component, and a second gas product enriched in a second more strongly adsorbed gas component, wherein each of said adsorbers is at least partially filled with solid adsorbent, which comprises the steps of:
synchronizing the steps, such that the five parallel adsorbers, A, B, C, D, and E, operate the same and in a coordinated fashion, such that each of the five parallel adsorbers is out-of-phase from the other adsorbers by 2π/5, characterized in that:
Adsorber A undergoes Feed (“FD”), with simultaneous production of the first product gas in the same elapsed time as:
Adsorber B sequentially undergoes Pressure Equalization 1 (Effluent)=“PE1(E)”+Pressure Equalization 2 (Effluent)=“PE2(E)”+Pressure Equalization 3 (Effluent)=“PE3(E)” while
Adsorber C sequentially undergoes Blowdown=“BD”+Evacuation=“EV”+Purge=“PU”+Pressure Equalization 3 (Influent)=“PE3(I)” while
Adsorber D sequentially undergoes Pressure Equalization 2 (Influent)=“PE2(I)” while
Adsorber E sequentially undergoes Pressure Equalization 1 (Influent)=“PE1(I)”+Repressurize with Product=“RP”;
wherein synchronization of the steps requires that:
Pressure Equalization 1 (Influent)=“PE1(I)” coincides with Pressure Equalization 1 (Effluent)=“PE1(E)”;
Pressure Equalization 2 (Influent)=“PE2(I)” coincides with Pressure Equalization 2 (Effluent)=“PE2(E)”; and
Pressure Equalization 3 (Influent)=“PE3(I)” coincides with Pressure Equalization 3 (Effluent)=“PE3(E)”;
provided that the elapsed time of the Feed Step in adsorber A coincides with the sequence of steps: Blowdown=“BD”+Evacuation=“EV”+Purge=“PU”+Pressure Equalization 3 (Influent)=“PE3(I)” in adsorber C; provided further that adsorbers B, D, and E are not so limited when Hold Steps are inserted between one or more of adsorbers B, D, and E.

11. The PSA process of claim 10, wherein said gas mixture comprises natural gas containing an undesirably high level of nitrogen.
